(19) United States
(12) Patent Application Publication
(10) Pub. No.: US 2014/0250252 A1
(43) Pub. Date: Sep. 4, 2014

(54) First-in First-Out (FIFO) Modular Memory Structure

(71) Applicant: SILICON GRAPHICS INTERNATIONAL CORP., Fremont, CA (US)

(72) Inventor: Eric C. Fromm, Eau Claire, WI (US)

(73) Assignee: SILICON GRAPHICS INTERNATIONAL CORP., Fremont, CA (US)

(21) Appl. No.: 13/784,160

(22) Filed: Mar. 4, 2013

(51) Int. Cl. G06F 5/06; G06F 13/16

(52) U.S. Cl. CPC G06F 5/065; G06F 13/1689
USPC 710/310

(57) ABSTRACT

A modular first-in first-out circuit including at least three non-addressable memory blocks forming a data pipeline is disclosed. At least two of the memory block including a data storage structure for receiving as input data from a global data bus and a control logic structure including logic for determining whether data should be added to the data storage structure from the global data bus and whether any data within the data storage structure should be transferred to the output of the memory block. The data storage structure of the at least two memory blocks includes a first data input for selectively receiving data from the global data bus and a second data input for selectively receiving data from a previous memory block in the modular first-in first-out circuit.

### FIELD OF THE INVENTION

The invention generally relates to memory circuitry and, more particularly, the invention relates to first-in first-out memory circuitry.

### BACKGROUND OF THE INVENTION

Traditional First-in First-outs (FIFOs) were constructed with a series of pipelined latches where data moves through the pipeline on each clock cycle. Thus, the FIFO has a single tail data element that receives data and a single head data element from which data may be read. One major problem with this type of design is that data received at the FIFO data input will not appear at the FIFO output until it has rippled through each of the elements intervening between the input and output elements. As such, there is inherent latency in such a design.

To overcome the latency problem of traditional FIFO designs, current FIFO implementations are often built using ordinary Random Access Memory (RAM) blocks having address and data ports for writing data into and reading data out. Associated logic is included which keeps track of EntryValid state and manipulates the read and write addresses of the RAM block to emulate the FIFO function. The physical size and access times of a RAM block and therefore a RAM-based FIFO are strongly affected by the amount of decoding multiplexing and demultiplexing circuitry necessary to provide the random access functionality (i.e., addressing). As a result, the larger the RAM, the slower the access time and the slower the FIFO will operate.

### SUMMARY OF VARIOUS EMBODIMENTS

In accordance with one aspect of the invention, a first-in first-out circuit including at least three memory blocks forming a data pipeline is disclosed. At least two of the memory blocks includes a data storage structure for receiving as input data from a global data bus and a control logic structure including logic for determining whether data should be added to the data storage structure from the global data bus and whether any data within the data storage structure should be transferred to the output. The data storage structure of the at least two memory blocks includes a first data input for selectively receiving data from the global data bus and a second data input for selectively receiving data from a previous memory block in the first-in first-out circuit.

The output of the first memory block is coupled to the input of the data storage structure of the second memory block and the first and second memory blocks are adjacent to each other in the data pipeline. Each of the memory blocks includes an input for receiving an add signal and an input for receiving a remove signal. Each of the add inputs may be coupled together to an add bus and each of the remove signals may be coupled together to a remove bus. In certain embodiments, the add and remove buses are combined together and different signaling commands are provided for add and remove.

In certain embodiments, one of the memory blocks includes only a selective input to a global data bus and a second input to the output of its respective data storage structure. This memory block would be the last memory block to receive data before the FIFO circuit is full.

The control logic structure for at least two of the memory blocks generate a select signal and a load signal wherein the select signal selects the input of the data storage structure and the load signal indicates whether data should be read into a memory element or the memory element should maintain its data state.

Each of the memory blocks may be coupled to a global add bus for receiving an add command and each of the memory blocks may also be coupled to a global remove bus for receiving a remove command. In certain embodiments, the add command may be a one bit signal. In certain embodiments, the remove command may be a one bit signal.

In embodiments of the FIFO circuit, the data storage structure for each memory block is connected in series with a data storage structure of an adjacent memory block. The data storage structure may form a clocked pipeline.

The control logic structure of each memory block may receive as input an add command and a remove command. The control logic structure may determine based at least on the add and remove commands, a select signal and a load signal. The select signal causes the data storage structure to couple either to the global data bus or to the output of an adjacent memory block. The load signal causes data to be loaded into the data structure or data to be maintained in the data storage structure.

The control logic structure of each memory block maintains state information. The state information may include whether the block is the tail memory block element and whether the memory block contains valid data. The control logic structure may use valid and tail status values to determine the select and load signals. Each of the memory blocks may also include one or more inter-memory block connections for providing status information to an adjacent memory block.

Also disclosed is a method for operating a hardware-based first-in first-out pipelined memory circuit having non-addressable memory blocks. The pipelined memory circuit includes a fixed head memory block that outputs data from the pipelined memory circuit and a variably positioned tail memory block to which data may be added from a data bus into the pipelined memory circuit. An add data command is provided on a global bus that is coupled to each of the memory blocks of the memory circuit. Each memory block determines if the memory block itself is the tail memory block, and if so, data is allowed to be added to the memory block from a global data bus that is coupled to each of the memory blocks. On a subsequent clock cycle, the memory block identified as the tail memory block deasserts its status as the tail memory block and the block immediately preceding this block is identified as the tail memory block.

The pipeline memory circuit may have a synchronous clock shared by the memory blocks or the FIFO circuitry may run asynchronously or using any other type of clocking scheme. The memory blocks each may include a data storage structure and a control logic structure. For each memory block, the control logic structure determines a load signal for either causing the data storage structure to load data into an associated memory element or maintaining the present value of the memory element. The control logic structure may also determine a select control bit based upon the tail bit of the memory block for selecting an input to the memory block from a plurality of inputs. The inputs may include the global data bus and an output of a preceding memory block.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an example of a modular memory block for use in the construction of a FIFO with local control;

FIG. 2 shows a more detailed embodiment of the modular memory block including an exemplary data storage structure and communication signals

FIG. 3 is an example of a FIFO constructed from modular memory blocks with a fixed head position and variable tail position; and

FIG. 4 is an example of FIFO of rank 4 constructed from modular memory blocks having local control signaling wherein an add command is asserted.

### DESCRIPTION OF ILLUSTRATIVE EMBODIMENTS

As used in the present application, the term “bus” shall refer to a connection between multiple inputs or output of a circuit structure such as a FIFO. The “bus” is capable of carrying data and/or command signals to each memory block within the FIFO. The term “bus” is not used to suggest or imply that addressing information accompanies either data or commands on the bus. Further, a bus may be either serial or parallel and therefore can either transmit data as serial or parallel information.

The term “element” shall refer to basic level circuitry. For example, a register formed from a flip-flop or a latch would be a memory element. A memory element could store one or more bits of information, such as, 16, 32, or 64 bit data word.

The term “structure” shall refer to a level of circuitry above a basic level of circuitry and may include multiple elements. For example, a data storage structure may be constructed of a memory element and multiplexor which are both elements.

The term “block” shall refer to a higher level of circuitry as compared to a structure. Thus, a block will include at least one structure and another element or structure. Blocks can be combined together to form larger logical circuits.

In illustrative embodiments, a first-in first-out (FIFO) circuit and modular memory blocks for implementing such a FIFO circuit are disclosed. The inventive design reduces the number of global bus connections to the circuit wherein each memory block includes internal logic for determining if data should be read from the memory block or added to the memory block. Thus, the FIFO circuit includes a single head memory element from which data is read and a variably positioned tail memory element. Thus, there are no empty memory elements without validly written data between other memory elements that have validly written data. As a result, the queue formed by the pipelined memory elements does not have any gaps. Details of illustrative embodiments are discussed below.

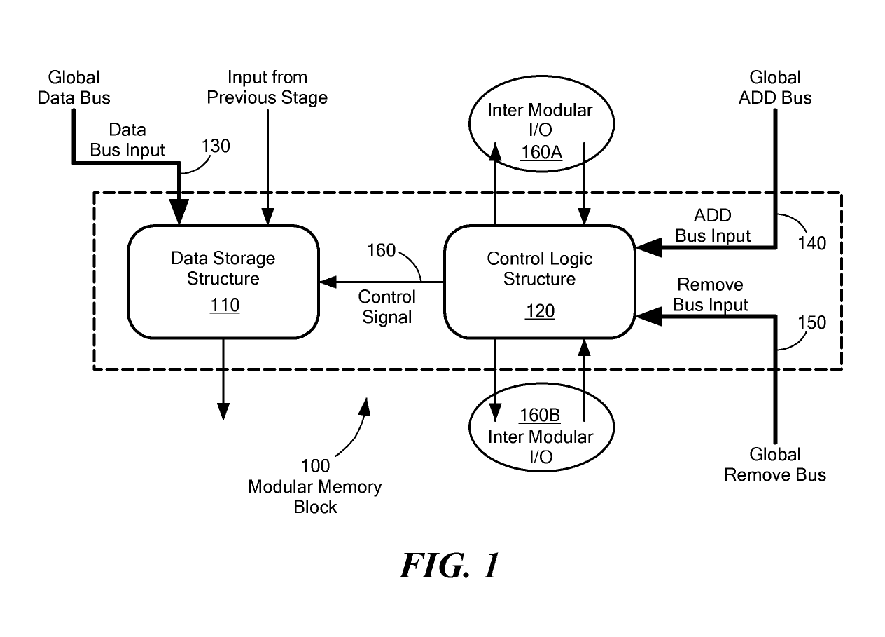

FIG. 1 shows an embodiment of a modular memory block 100 that can be used to construct a large-scale FIFO circuit that does not require a global addressing scheme and does not suffer from the resultant time delay associated with global address decoding. Additionally, the present modular memory block 100 when implemented as a FIFO does not require the data fan-in of a conventional SRAM FIFO.

The present modular memory block 100 contains locally generated control signals that allows the modular memory block 100 to determine whether its data storage structure 110 in the pipeline of data storage structures is both empty and also the tail data storage structure. It should be recognized that in a FIFO, the head is the data storage structure from which an externally requesting device obtains data and the tail is the data storage element into which data may be added. If the data storage structure 110 is empty and is determined to be the tail position, the control logic structure 120 of the memory block 100 causes data to be written directly into its data storage structure 110. Additionally, the memory block will update its tail status as not being the tail position of the FIFO. The modular memory block 100 has three global bus inputs (130, 140, and 150). The global bus inputs include a data bus input 110, an “add” command bus input 140 and a “remove” command bus input 150. The memory block 100 includes a data storage structure 110 and a control logic structure 120. The data storage structure 110 may be one or more registers formed from flip-flops or latches and may include one or more multiplexors that receive control signals 160 from the control logic structure 120.

The modular memory block of FIG. 1 also includes intermodular inputs/outputs (I/O) for both the previous modular memory block and the subsequent modular memory block (160A and 160B). These intermodular I/Os allow adjacent control logic structures to communicate state information, such as a tail state and a valid state. For example, each control logic structure may have two associated memory locations: one for storing a one-bit status bit indicating that the data storage structure contains valid data and a second one-bit status bit indicating whether the modular memory block (and therefore the data storage structure) is the tail of the FIFO.

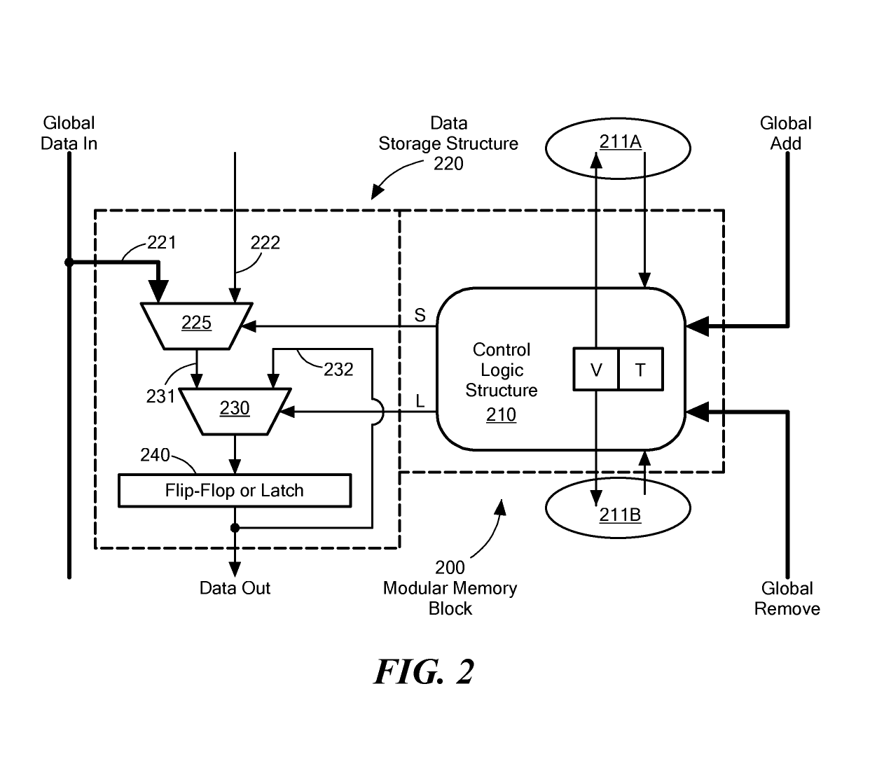

FIG. 2 shows a more detailed embodiment of the modular memory block of FIG. 1. The modular memory block 200 can be divided into a data storage structure 220 and also a control logic structure 210. As shown, the data storage structure 220 includes a first multiplexor 225 that has two data inputs for: 1. connection to the global data bus 221 and 2. for connecting to the output of the data storage structure of the adjacent modular memory block 222. The first multiplexor is controlled by the control logic structure 210 that provides a select signal (S) to the multiplexor for selecting between input 221 (data bus) and input 222 (previous data storage structure in the pipeline).

The data storage structure 220 also includes a second multiplexor 230 and a memory element (e.g., a flip-flop or latch) 240. The memory element 240 may have different word lengths in different embodiments. The second multiplexor is controlled by the control logic structure 210 and receives as input a load command (L) for loading data into the memory element 240. The load command signals whether data is advanced (i.e., new data is added to the memory element or if the memory element maintains its present state). Input 231 is coupled to the output of the first multiplexor 225 and input 232 feeds back from the output of the memory element 240.

The control logic structure 210 is a processing circuit for performing a number of predefined logical statements and producing the control signals S (select) and L (load) for controlling the first and second multiplexors 225 and 230. The control logic structure 210 receives as input add and remove commands from the global bus/busses and also maintains state information about the modular memory block. The control logic structure 210 either includes or has access to two memory cells that may be one-bit in size that indicate whether the modular memory block is the tail of the pipeline T=true and whether the data storage structure is presently storing data (i.e., valid data V=true). In addition to add, remove, V and T, the control logic structure 210 receives as input the values of V and T for the adjacent modular memory blocks through the I/O ports 211A and 211B. The control logic structure 210 uses the following logic statements for determining the control state of the S (select) and L (load) signals. It should be understood by one of ordinary skill in the art that the present logic sequence is for illustrative purposes only and that other logic will produce a similar result. For example, the logic may be inverted and connections reversed and still produce the same results. The purpose of the logic is to cause data to be added to the FIFO without gaps (i.e., modular memory elements having no data with other modular memory elements further up the pipeline having data) developing between modular memory blocks. Thus, the logic determines the values for V and T for the next clock cycle as well as the S and L values.

Sₙ^{t}=Tₙ^{t} or (RMV and Tₙ₋₁^{t})

Lₙ^{t}=(ADD and Sₙ^{t}) or (RMV and Vₙ₋₁^{t})

Vₙ^{t+1}<=Lₙ^{t} or (Vₙ^{t} and not RMV)

Tₙ^{t+1}<=(Tₙ₊₁^{t} and ADD and not RMV) or (Tₙ₋₁^{t} and not ADD and RMV) or (Tₙ^{t} and ADD xnor RMV)

Wherein t=time; n=the number of modular memory block or rank number; S=the rank load select; L=rank load control; T=the rank tail state; and V=rank valid state.

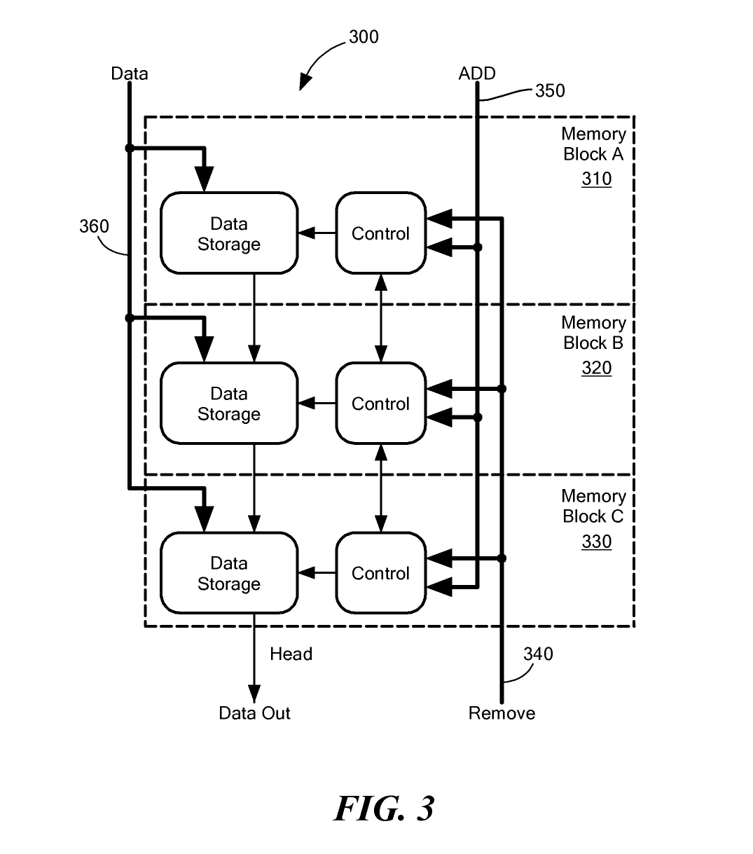

FIG. 3 shows the modular memory blocks coupled together to form a FIFO structure 300. As shown, the FIFO includes three levels (MEM BLOCKS A,B,C) 310, 320, 330. Three levels are provided for exemplary purposes only. The FIFO can be of any length without deviating from the intended scope of the invention. In this FIFO, the head memory block is fixed, which is memory block C 330. The head memory block 330 provides data to the data output and when a remove request is signaled on the remove bus 340, data is removed from the memory block 330. Data is passed from the data bus to an empty memory block in the FIFO called the tail memory block when an add request is signaled on the add bus 350. It should be recognized by one of ordinary skill in the art that the add and remove buses may be combined together to form a single bus without deviating from the scope of the invention. Thus, the bus may provide one or more command signals to each of the memory blocks 310, 320, 330. Each of the busses Data 360, Add 350, and Remove 340 are electrically coupled and in communication with each of the memory blocks. It should be recognized that memory block A 310, only has a single input that is connected to the data bus and does not include a second input as do block B 320 and block C 330 to predecessor memory blocks in the FIFO pipeline, since block A 310 is the first memory block of the FIFO. The tail of the FIFO, which is the last memory block that does not contain data and is also closest to the head memory block varies depending upon the state of the FIFO. Thus, in this example, either memory block A, B, or C may be the tail of the FIFO depending on the data that is in the FIFO.

Each memory block determines its own status including whether the memory block has valid data “V” and whether the memory block is the tail “T”. The control of data including which input to select i.e., either the data bus or the previous memory block is internally determined by the logic of the individual memory block. Thus, there is no need for global addressing. Additionally, the control logic structure of each memory block contains connections to the nearest neighbor memory blocks. As shown, the control logic structure of block B is connected to the status information of both block A and block C. Memory block A is connected to the status information of memory block B and memory block C is connected to the status information of memory block B. Thus, the tail status and whether the memory block contains valid data is accessible to its predecessor and successor memory blocks in the FIFO. The logic internal to the each memory block enables the pipeline to contain data and not have any gaps in the pipeline between valid data. Thus, the logic would prevent the situation where data is in memory block C and memory block A where block B is empty. If memory block C contains data, the logic will determine that data should be placed into memory block B when an add command is received. Thus, data will be read from the data bus into memory block B and not into memory block A. By keeping the queue of the pipeline compact without gaps, a requesting external device will not have to wait extra clock cycles for valid data to be available at the head of the FIFO.

It should be recognized that no clocking signals are shown in the figures. The present configuration may operate with a synchronous, an asynchronous or any other clocking schema including variations of synchronous and asynchronous. In some embodiments, clocking may be run synchronously wherein a clock is commonly shared by all of the structures within the FIFO. Thus, the clock signal is delivered to each structure and element so that they only assume new values during clock pulses. It should also be recognized that circuitry external to the FIFO that drives the FIFO inputs and samples the FIFO outputs would be regimented by the same clocking signal. For example, pushing data into the FIFO would require the external circuitry to both assert an add command and present the associated data at the beginning (or at least before the end) of a clock cycle. If no data is to be pushed into the FIFO in the subsequent clock cycle, the external circuitry would have to de-assert the add command at the beginning (or at least by the end) of the clock cycle. The add command must be stable in the asserted or de-asserted states. In an asynchronous operation, there is no periodic clock signal that is used to enable state changes in the FIFO. It should be clear to one of ordinary skill in the art that the present invention is not limited by its clocking schema and that synchronous, asynchronous and other clocking schema may be used without deviating from the intended scope of the invention.

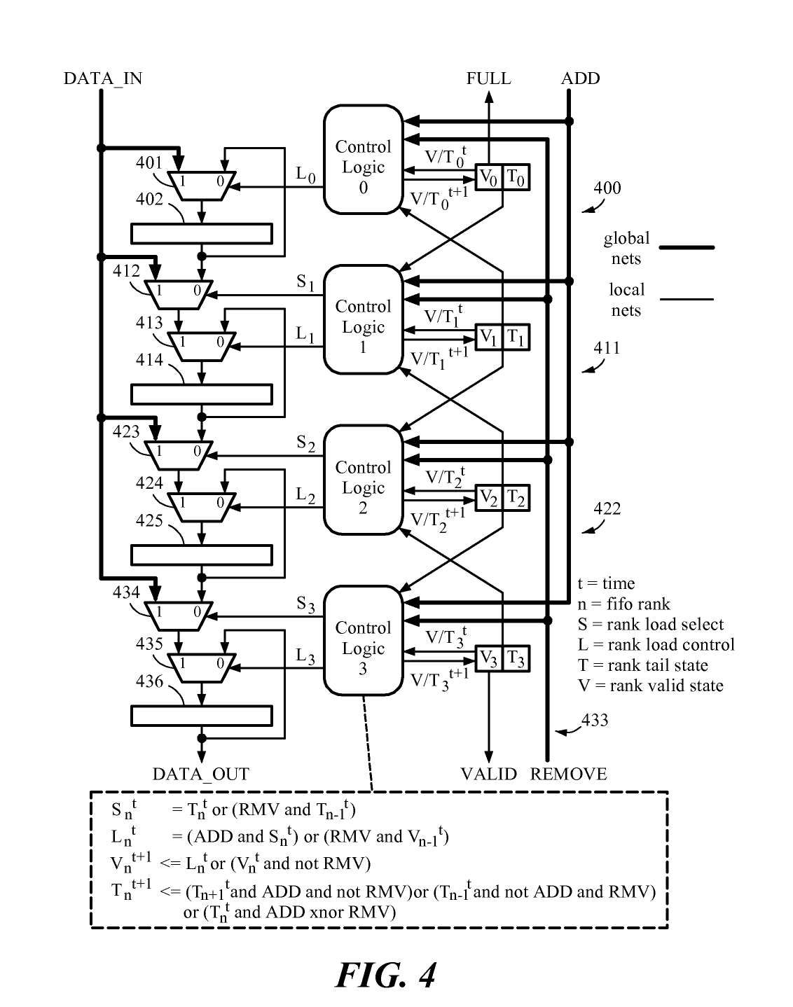

In order to avoid the FIFO from overflowing, the FIFO outputs a full signal when all of the memory blocks are full within the FIFO. Thus, to avoid an error condition, external circuitry should recognize the full signal and not add data to the FIFO. The “FIFO full” signal may be implemented as an output data line from the first memory block in the FIFO (see FIG. 4 memory block 0) where if the valid bit, V of the first memory block is asserted, then the FIFO is full.

FIG. 4 shows an exemplary rank four FIFO (i.e., four modular memory blocks) 410 in which data is stored initially in memory blocks three 433 and two 422 and memory blocks zero 400 and one 411 are empty. Four memory blocks are shown for exemplary purposes and it should be understood that the FIFO may include any number of memory blocks. The same logic provided above with respect to FIG. 2 is provided in FIG. 4 Each memory block includes a data storage structure and a control logic structure. Each data storage structure includes at least one multiplexor and a memory element, such as a register formed from a flip-flop or latch. The FIFO internally generates control signals, select S, Load L, Valid, and Full, wherein Valid indicates that there is valid data in the head memory block and Full indicates that all of the memory blocks in the FIFO contain valid data. Additionally, each memory block maintains state information including valid (V) and tail (T).

As shown, the inputs of each of the multiplexors (401,412,413,423,424,434,435) are labeled to indicate for what state a control bit (0,1) (e.g., either S or L) will cause a connection to its input. As shown in the present implementation, each multiplexor is a 2-to-1 multiplexor and therefore the control signal only needs to be one bit in length. It should be recognized that other multiplexing structures may be substituted and other logic producing the same results may be used without deviating from the present invention.

Before an add command is issued, the state of:

memory block zero 400 is T=0, V=0, L=0

memory block one 411 is T=1, V=0, S=1, L=0

memory block two 422 is T=0 , V=1, S=0, L=0

memory block three 433 is T=0 , V=1, S=0, L=0.

Thus, only memory block one has an enabled latch signal, so that the first multiplexor of memory block one is coupled to the data input. The first multiplexor of memory blocks two and three are coupled to the output of the preceding memory block in the pipeline. It should be recognized that each of the second multiplexors have their inputs coupled to their outputs and therefore maintain the current data state within each of the memory blocks. However, memory blocks two and memory blocks three are the only blocks with valid data.

On the next clock cycle or at some point after the state described, when an add command is issued on the add bus and no remove command is issued, the control logic structure for each memory block determines the control commands S and L as follows:

Memory block zero 400 S=0 L=0
Memory block one 411 S=1, L=1
Memory block two 422 S=0, L=0
Memory block three 433 S=0, L=0.

Thus, the first multiplexor of memory block one 412 has its input coupled to the data bus and the second multiplexor 413 is set to pass the data from the data bus to the memory element. For memory blocks zero 400, two 422 and three 433, L=0 and S=0 for blocks two 422 and three 433. Thus, memory block zero 400, two 422 and three 433 each holds their data state.

The select command for a given memory block is asserted when the memory block is designated the tail memory block (i.e., the closest memory block to the head without valid data) or if a remove command signal is received and the preceding memory block was the tail. In such a situation, data is removed from the FIFO and all of the memory blocks containing data are passed to the next/subsequent memory block. Thus, the memory block adjacent to the tail that has valid data will have an asserted select command and will be coupled to the data bus. In this scenario, the memory block adjacent to the tail on the previous cycle with the select command asserted will become the tail on the next cycle. Thus, data is always placed into the pipeline in a memory block that is the tail memory block and there is data in all data blocks closer to the head or the memory block is the head.

It should be recognized by one of ordinary skill in the art that other combinations of memory blocks containing data, along with combinations of signals including full, add, remove, and valid (i.e., V status of memory block three being asserted true or =1 as shown in FIG. 4) may occur and that the FIFO would operate in accordance with the provided logic.

Although the above discussion discloses various exemplary embodiments of the invention, it should be apparent that those skilled in the art can make various modifications that will achieve some of the advantages of the invention without departing from the true scope of the invention.

What is claimed is:

1. A first-in first-out circuit including at least three memory blocks, wherein
at least two of the memory blocks each comprises:
an output;
a data storage structure for receiving as input data from a global data bus;
a control logic structure including logic for determining whether data should be added to the data storage structure from the global data bus and whether any data within the data storage structure should be transferred to the output.

2. A first-in first-out circuit according to claim 1, wherein the data storage structure includes a first data input for receiving data from the global data bus and a second data input for receiving data from a previous memory block.

3. A first-in first-out circuit according to claim 2, wherein the output of a first memory block is coupled to the input of a data storage structure of a second memory block and wherein the first memory block is adjacent to the second memory block.

4. A first-in first-out circuit according to claim 1, wherein the at least two memory blocks each include an input for receiving an add data control signal from a global add signaling bus and an input for receiving a remove data control signal from a global remove signaling bus.

5. A first-in first-out circuit according to claim 1, wherein the add data control signal and the remove data control signal are each one bit signals.

6. A first-in first-out circuit according to claim 1, wherein one of the at least three memory blocks comprises:
an output;
a data storage structure for receiving as input data from a global data bus;
a control logic structure including logic for determining whether data should be added to the data storage structure from the global data bus.

7. A first-in first-out circuit according to claim 1, wherein the data storage structure for each memory block is connected in series with a data storage structure of an adjacent memory block.

8. A first-in first-out circuit according to claim 1, wherein the data storage structures of the first-in first-out circuit form a pipeline.

9. A first-in first-out circuit according to claim 1, wherein the control logic structure receives an add data control signal and a remove data control signal from one or more global data busses and the control logic structure determines based at least upon the add data control signal and the remove data control signal, a select signal for causing the data storage structure to couple either to the global data bus or to the output of an adjacent memory block and a load signal for causing data to be loaded into the data structure or data to be maintained in the data storage structure.

10. A first-in first-out circuit according to claim 9, wherein the control logic structure includes a tail state memory and a valid state memory each having a status, and wherein the status of the tail state and the status of the valid state are used in setting the load signal and the select signal.

11. A first-in first-out circuit according to claim 10, wherein the control logic structure includes an inter-memory block connection for providing the status of the tail state and the status of the valid state to an adjacent memory block.

12. A method for operating a hardware-based first-in first-out pipelined memory circuit having at least three non-addressable memory blocks wherein there is a head memory block that outputs data from the pipelined memory circuit and a variably positioned tail memory block to which data may be added from a data bus into the pipelined memory circuit, the method comprising:
providing an add data command to a global bus coupled to each of the memory blocks;
for each memory block:
determining if the memory block is the tail memory block;
if the memory block is the tail memory block, allowing data to be added to the memory block from a global data bus coupled to each of the memory blocks.

13. The method according to claim 12, further comprising deasserting the status of the memory block as the tail memory block.

14. The method according to claim 12, further comprising on a next clock cycle, identifying the preceding memory block to the memory block in the pipeline as the tail memory block.

15. The method according to claim 12, wherein the pipelined memory circuit has a synchronous clock shared by the memory elements.

16. The method according to claim 12, wherein each memory block includes a data storage structure and a control logic structure.

17. The method according to claim 16, wherein the control logic structure of each memory block includes a valid bit indicating that data exists in the respective data storage structure.

18. The method according to claim 16, wherein the control logic structure of each memory block includes a tail bit indicative of whether the memory block is the tail memory block.

19. The method according to claim 16, further comprising:
for each memory block, the control logic structure:
determining a load set signal for causing the data storage structure to load data into an associated memory element.

20. The method according to claim 16, further comprising:
determining a select bit based on the tail bit for the memory block, the select bit for selecting an input to the memory block from a plurality of inputs.

21. The method according to claim 20, wherein the inputs to the memory block include the global data bus and an output of a preceding memory block.
